(19) United States
(12) Patent Application Publication
(10) Pub. No.: US 2026/0187708 A1
(43) Pub. Date: Jul. 2, 2026

(54) PERSONALIZED CONTENT ON A SECURE COMMERCE NETWORK

(71) Applicant: Goodwell Technologies, Inc., Bellevue, WA (US)

(72) Inventors: John COFANO, Sammamish, WA (US); David BOLIEK, Carnation, WA (US); Phillip DELLINGER, Bothell, WA (US)

(21) Appl. No.: 19/436,967

(22) Filed: Dec. 30, 2025

Related U.S. Application Data
(60) Provisional application No. 63/740,392, filed on Dec. 31, 2024.

(51) Int. Cl. G06Q 30/0601

(52) U.S. Cl. CPC G06Q 30/0641

(57) ABSTRACT

The present disclosure provides a system for dynamically reconfiguring an e-commerce storefront based on referral source, comprising a connection agreement established between a referring partner and an e-commerce store, wherein both parties contribute configuration elements. The system comprises a JSON-based contextual configuration document that specifies reconfiguration instructions including visual modifications to the storefront appearance, catalog filtering and product presentation rules, pricing and promotional adjustments, and content injection and messaging. The system comprises a plugin component on the e-commerce platform that intercepts incoming referred traffic, extracts and validates the configuration document, applies reconfigurations before page rendering, and maintains the reconfigured state during the shopping session. The e-commerce storefront presents a different experience to each customer based on their referral source while using the same underlying platform and inventory.

### FIELD OF INVENTION

The present disclosure relates to e-commerce website personalization systems, and more particularly to a dynamic e-commerce storefront reconfiguration system that automatically transforms online store appearance, functionality, and content based on referral source context through bidirectional configuration agreements between referring partners and e-commerce stores.

### BACKGROUND

E-commerce websites have become a dominant force in retail, with millions of online stores competing for customer attention and sales. These websites typically present a standardized experience to all visitors, regardless of how they arrived at the site or what their specific interests might be. While this approach simplifies website management and maintenance, it may not provide the personalized experience that modern consumers have come to expect.

The growth of digital marketing has led to complex ecosystems where customers frequently navigate between multiple websites, applications, and platforms before making purchasing decisions. Customers might discover products through social media influencers, content creators, affiliate marketers, comparison shopping sites, or partner applications before being directed to an e-commerce store. However, when customers transition from these referring sources to the target e-commerce website, they often encounter a generic landing page that bears no relation to their previous browsing context or the content that initially attracted their interest.

Traditional referral systems in e-commerce typically involve simple link redirections where referring partners send traffic to predetermined landing pages on merchant websites. These systems generally lack the ability to dynamically modify the shopping experience based on the referring source or customer context. As a result, the continuity of the customer journey is often broken, potentially leading to reduced engagement and conversion rates.

Many e-commerce platforms offer limited customization options that require technical expertise to implement and maintain. Creating unique landing pages or experiences for different referral sources often involves significant development resources and ongoing maintenance. This technical complexity can be a barrier for smaller merchants or those without dedicated development teams.

The challenge of maintaining contextual relevance becomes more pronounced as the number of referral sources increases. Each partnership or marketing channel may have different audiences, messaging strategies, and promotional offers, yet most e-commerce systems lack the flexibility to accommodate these variations without extensive custom development work.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a system for dynamically reconfiguring an e-commerce storefront based on referral source is provided. The system comprises a connection agreement established between a referring partner and an e-commerce store, wherein both parties contribute configuration elements. The system comprises a JSON-based contextual configuration document that specifies reconfiguration instructions including visual modifications to the storefront appearance, catalog filtering and product presentation rules, pricing and promotional adjustments, and content injection and messaging. The system comprises a plugin component on the e-commerce platform that intercepts incoming referred traffic, extracts and validates the configuration document, applies reconfigurations before page rendering, and maintains the reconfigured state during the shopping session. The e-commerce storefront presents a different experience to each customer based on their referral source while using the same underlying platform and inventory.

According to other aspects of the present disclosure, the system may include one or more of the following features. The connection agreement may include source partner contribution specifications, target store contribution specifications, mutual approval requirements, and modification workflows requiring bilateral consent. The JSON configuration document may support template variables for dynamic content insertion, conditional logic for customer segmentation, A/B testing variants for optimization, and progressive enhancement based on device capabilities. The system may further comprise customer context preservation wherein the customer's journey from the referring site is maintained, personalization data is securely transmitted, shopping cart contents can be pre-populated, and customer preferences influence the reconfiguration. The plugin component may include security validation comprising configuration signature verification, timestamp validation to prevent replay attacks, schema validation to prevent injection attacks, and sandboxed execution of custom scripts. The system may further comprise a system for adaptive storefront reconfiguration that evolves during the customer journey, comprising initial reconfiguration based on referral source, progressive reconfiguration based on customer actions including products viewed adjusting recommendations, time on site triggering engagement features, cart contents influencing upsell displays, and exit intent activating retention offers, and session persistence maintaining reconfiguration across multiple page views, cart and checkout processes, return visits within a time window, and cross-device sessions. The system may further comprise a system enabling multiple parties to contribute to storefront reconfiguration, comprising a primary partner providing base configuration, secondary contributors adding layers including payment providers offering financing options, shipping partners providing delivery options, warranty providers adding protection plans, and charity partners enabling donation options, conflict resolution determining precedence when configurations overlap, and revenue sharing based on configuration contribution.

According to another aspect of the present disclosure, a computer-implemented method for transforming an e-commerce storefront in real-time based on referral context is provided. The method comprises receiving an encrypted configuration payload with an incoming customer referral. The method comprises decrypting the configuration payload to extract reconfiguration instructions. The method comprises applying visual transformations including injecting partner branding elements, modifying color schemes and typography, replacing or augmenting hero banners, and customizing navigation elements. The method comprises applying catalog transformations including filtering products to show only relevant categories, creating virtual collections specific to the referral source, reordering product displays based on partner preferences, and highlighting partner-recommended items. The method comprises applying pricing transformations including automatic discount application, partner-specific promotional codes, modified shipping thresholds, and exclusive bundle offerings. The method comprises rendering the transformed storefront to the customer within 100 milliseconds of request reception.

According to other aspects of the present disclosure, the method may include one or more of the following features. Visual transformations may include CSS injection with scoped selectors, JavaScript-based DOM manipulation, responsive design adjustments, and animation and transition effects. Catalog transformations may include machine learning-based product recommendations, collaborative filtering using partner audience data, real-time inventory checking for availability, and geographic filtering based on customer location. Pricing transformations may include dynamic pricing based on customer lifetime value, time-limited offers with countdown timers, quantity-based bulk discounts, and cross-sell and upsell recommendations. The method may further comprise encrypting customer data at the source using AES-128-CBC encryption with organization-specific keys, transmitting encrypted data within the configuration payload along with initialization vector, validating transfer timestamp to ensure data freshness within a 2-hour window, decrypting data at the target store using the organization's decryption key, using customer data to enable pre-filled checkout forms, personalized greetings and messaging, location-based inventory display, and order history tracking, and maintaining audit logs of all data access operations. The method may further comprise tracking metrics for each configuration including conversion rates, average order values, time to purchase, and cart abandonment rates, an A/B testing framework comparing different reconfiguration variants, reconfigured vs. non-reconfigured experiences, and timing of reconfiguration application, machine learning optimization predicting optimal configurations, personalizing based on customer segments, and automatically adjusting underperforming configurations, and attribution tracking linking sales to specific reconfigurations.

According to another aspect of the present disclosure, a plugin system for enabling dynamic reconfiguration across multiple e-commerce platforms is provided. The plugin system comprises platform-specific adapters for Shopify using Liquid template modification and Script Tags, BigCommerce using Page Builder API and Script Manager, Magento using Layout XML and Observer patterns, Salesforce Commerce Cloud using ISML templates and cartridges, WooCommerce using WordPress hooks and filters, and custom platforms using REST/GraphQL APIs and SDKs. The plugin system comprises a unified reconfiguration engine that interprets platform-agnostic JSON configurations, translates configurations to platform-specific modifications, and maintains consistency across different platforms. The plugin system comprises security validation including configuration signature verification, timestamp validation to prevent replay attacks, schema validation to prevent injection attacks, and sandboxed execution of custom scripts. A single configuration format can reconfigure stores on different e-commerce platforms.

According to other aspects of the present disclosure, the plugin system may include one or more of the following features. Platform-specific adapters may modify server-side rendering before page generation, inject client-side scripts for progressive enhancement, integrate with platform-native features, and maintain platform-specific optimizations. The unified reconfiguration engine may include a configuration cache for performance optimization, fallback mechanisms for unsupported features, version compatibility checking, and graceful degradation for older platforms. The plugin system may further comprise a distributed system for managing reconfigurations at scale, comprising a centralized configuration repository storing all active configurations, edge caching distributing configurations geographically, real-time synchronization ensuring configuration consistency, load balancing distributing reconfiguration processing, and failover mechanisms ensuring availability during outages. The plugin system may further comprise a marketplace of configuration templates, categories including industry-specific configurations, seasonal and holiday themes, partnership types, and conversion-optimized layouts, customization tools for adapting templates, performance data from other implementations, and automated compatibility checking with store platforms. The system may enable integrating content creator audiences with e-commerce stores through reconfiguration by content creator defining their brand elements and audience preferences, e-commerce store specifying compatible products and offers, generating a configuration that reflects the creator's aesthetic, highlights creator-endorsed products, provides exclusive creator audience pricing, and maintains creator narrative throughout purchase, and sharing revenue based on configuration-attributed sales. The system may enable adapting national e-commerce stores to local markets through reconfiguration by identifying customer geographic location from referral source, reconfiguring the storefront to show local store inventory and availability, regional pricing and promotions, local delivery and pickup options, and community-specific content and causes, and maintaining national brand consistency while enabling local customization.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 illustrates a flowchart for a dynamic e-commerce storefront reconfiguration method, according to aspects of the present disclosure.

FIG. 2 illustrates a flowchart for a computer-implemented method for transforming an e-commerce storefront in real-time, according to aspects of the present disclosure.

FIG. 3 illustrates a flowchart for a plugin system method for enabling dynamic reconfiguration across multiple e-commerce platforms, according to aspects of the present disclosure.

FIG. 4 illustrates a flowchart for a system setup process for dynamically reconfiguring an e-commerce storefront, according to aspects of the present disclosure.

FIG. 5 illustrates a block diagram of an e-commerce reconfiguration system, according to aspects of the present disclosure.

FIG. 6 illustrates a block diagram of a multi-platform plugin system for enabling dynamic reconfiguration, according to aspects of the present disclosure.

### DETAILED DESCRIPTION

The e-commerce reconfiguration system operates through twelve interconnected aspects that enable dynamic storefront transformation based on referral sources. A Switchboard Mapping Component may serve as a central processing element that maps incoming HTTP transfer requests to appropriate Contextual Configuration Document Templates. The Switchboard Mapping Component may analyze incoming requests to identify the correct template and may build outbound HTTP redirect requests containing the processed configuration data. In some cases, the mapping component may retrieve stored templates based on context codes and may populate the templates with relevant content assets to create complete configuration documents.

The system may utilize encrypted request templates through Referral Request Format Templates that incorporate encryption algorithms for generating secure HTTP redirect requests. These templates may contain Referral Request Documents as parameters and may ensure secure transmission of customer data and configuration information. In some cases, the encryption algorithms may use organization-specific keys to protect sensitive information during the transfer process. The templates may provide a standardized format for different referring partners while maintaining security protocols.

Special offer link processing may handle customer interactions when customers click on special offer links to be transferred to target ecommerce websites. The system may process these links to access special product or service offerings and may trigger the reconfiguration workflow. In some cases, the special offer links may contain embedded context codes that identify the specific configuration to be applied. The processing may involve validating the link parameters and may initiate the appropriate reconfiguration sequence.

Dual-level decryption may occur at both the Switchboard Service and Target Website Component Plugin levels for processing customer information and configuration documents. The Switchboard Service may decrypt incoming request parameters to extract customer data and context codes. In some cases, the Target Website Component Plugin may perform additional decryption to access the final configuration document. The dual-level approach may provide enhanced security and may allow for different encryption keys at each level.

A maintenance service interface may provide a website interface that allows referring and target website owners to setup context codes and manage referral configurations. The interface may enable administrators to create new referral relationships and may provide tools for configuring the reconfiguration parameters. In some cases, the maintenance service may include user authentication and may provide role-based access controls. The interface may support both referring website administrators and target website administrators with appropriate permissions.

Context Code Setup Templates may contain collections of elements for creating Contextual Configuration Documents linked to new Referral Context Codes. These templates may define the structure and available options for each type of referral relationship. In some cases, the templates may include visual elements, product categories, pricing rules, and content specifications. The setup templates may guide administrators through the configuration process and may ensure consistency across different referral partnerships.

Target Contextual Content may comprise collections of content assets used by the Switchboard Mapping Component to build Contextual Configuration Documents from templates. These assets may include images, text content, styling information, and promotional materials. In some cases, the content assets may be organized by context code and may be retrieved dynamically during the configuration process. The content collections may enable personalized experiences based on the referring source.

A bidirectional setup workflow may implement a setup process where target website administrators create referral context codes first, then notify referring website administrators to complete the setup with their assets. The workflow may ensure that both parties contribute their respective configuration elements. In some cases, the target website administrator may define the available products and pricing structures, while the referring website administrator may provide branding elements and customer context. The bidirectional approach may require approval from both parties before activation.

Multi-platform referrer types may encompass various consumer-facing applications beyond traditional websites, including iOS applications, Android applications, AI systems, and chat applications. The system may accommodate different referrer platforms through standardized interfaces and may adapt to platform-specific requirements. In some cases, mobile applications may use deep linking mechanisms, while AI systems may use API-based integrations. The flexibility may enable partnerships across diverse digital platforms.

A Switchboard Service may act as an intermediate service positioned between the referring website and target ecommerce website. The service may receive HTTP 302 redirect requests from referring sources and may process the requests to extract configuration information. In some cases, the Switchboard Service may perform validation, decryption, and template processing before generating outbound redirect requests to the target website. The intermediary architecture may provide centralized processing and may enable consistent handling across different partnerships.

HTTP 302 redirect methodology may serve as the specific technical method for transferring customers between referring websites and target ecommerce websites. The system may use HTTP 302 redirect requests to maintain seamless customer transitions while carrying configuration data. In some cases, the redirect requests may include encrypted parameters containing customer information and reconfiguration instructions. The 302 redirect approach may preserve the customer's browsing session and may enable real-time data transfer.

Session-persistent reconfiguration may maintain reconfigured website states during the entire shopping session, allowing customers to continue shopping with the personalized experience. The system may preserve the applied configurations across multiple page views, cart operations, and checkout processes. In some cases, the reconfiguration state may persist through return visits within a specified time window and may support cross-device sessions. The persistence may ensure consistent branding and personalization throughout the customer journey.

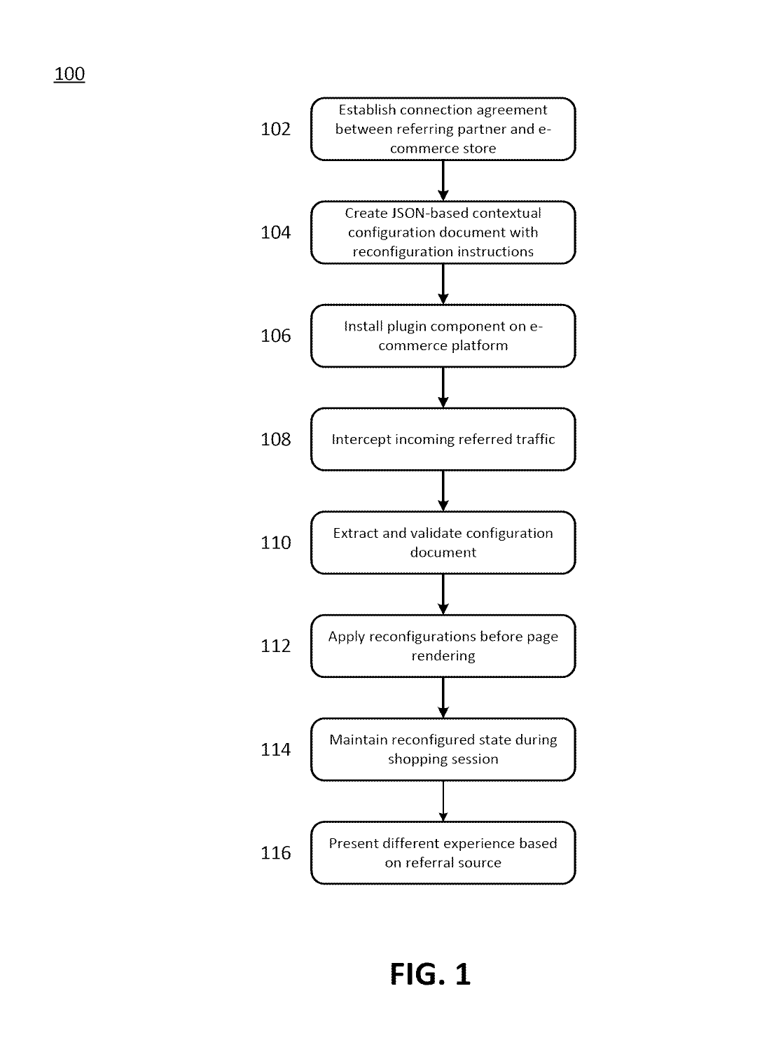

Referring to FIG. 1, a method 100 for dynamic e-commerce storefront reconfiguration may be implemented to enable adaptive transformation of online retail environments based on referral sources. The method 100 may begin with a step 102 where a connection agreement is established between a referring partner and an e-commerce store. In some cases, the connection agreement may define the collaborative framework wherein both parties contribute configuration elements, including source partner contribution specifications, target store contribution specifications, mutual approval requirements, and modification workflows requiring bilateral consent.

The method 100 may proceed to a step 104 where a JSON-based contextual configuration document is created with reconfiguration instructions. The JSON configuration document may specify visual modifications to the storefront appearance, catalog filtering and product presentation rules, pricing and promotional adjustments, and content injection and messaging. In some cases, the JSON configuration document may support template variables for dynamic content insertion, conditional logic for customer segmentation, A/B testing variants for optimization, and progressive enhancement based on device capabilities.

With continued reference to FIG. 1, the method 100 may advance to a step 106 where a plugin component is installed on the e-commerce platform. The plugin component may be configured to intercept incoming referred traffic, extract and validate the configuration document, apply reconfigurations before page rendering, and maintain the reconfigured state during the shopping session. In some cases, the plugin component may include security validation comprising configuration signature verification, timestamp validation to prevent replay attacks, schema validation to prevent injection attacks, and sandboxed execution of custom scripts.

The method 100 may continue to a step 108 where incoming referred traffic is intercepted by the plugin component. During this step, the plugin component may identify customers arriving from referring partners and prepare to apply the appropriate reconfiguration based on the referral source. The method 100 may then proceed to a step 110 where the configuration document is extracted and validated from the incoming referral request. In some cases, the extraction process may involve decrypting encrypted configuration payloads and validating the authenticity and integrity of the configuration data.

As further shown in FIG. 1, the method 100 may advance to a step 112 where reconfigurations are applied before page rendering. During this step, the plugin component may implement the visual modifications, catalog filtering, pricing adjustments, and content messaging specified in the JSON configuration document. The method 100 may then proceed to a step 114 where the reconfigured state is maintained during the shopping session. In some cases, the reconfigured state may persist across multiple page views, cart operations, and checkout processes to provide a consistent experience throughout the customer journey.

The method 100 may conclude with a step 116 where a different experience is presented to each customer based on their referral source while using the same underlying platform and inventory. In some cases, the e-commerce storefront may present customized visual elements, filtered product catalogs, adjusted pricing structures, and targeted messaging that corresponds to the specific referring partner and customer context.

The method 100 may further comprise a system for adaptive storefront reconfiguration that evolves during the customer journey. The adaptive reconfiguration system may include initial reconfiguration based on referral source, which may be implemented during the step 112 and step 116 phases of the method 100. In some cases, the initial reconfiguration may establish the baseline storefront appearance and functionality according to the referring partner's specifications and the customer's originating context.

The adaptive reconfiguration system may also include progressive reconfiguration based on customer actions. In some cases, the progressive reconfiguration may involve products viewed adjusting recommendations, where the system may modify product suggestions and related item displays based on the customer's browsing behavior. The progressive reconfiguration may further include time on site triggering engagement features, where extended browsing sessions may activate additional interactive elements, promotional offers, or assistance features to enhance customer engagement.

The progressive reconfiguration may additionally encompass cart contents influencing upsell displays, where the system may dynamically adjust cross-sell and upsell recommendations based on items added to the shopping cart. In some cases, the progressive reconfiguration may include exit intent activating retention offers, where the system may detect customer departure signals and present targeted incentives or special offers to encourage continued engagement and purchase completion.

The adaptive reconfiguration system may further include session persistence maintaining reconfiguration across multiple operational contexts. In some cases, the session persistence may maintain reconfiguration across multiple page views, ensuring that the customized storefront experience remains consistent as customers navigate through different sections of the e-commerce site. The session persistence may also maintain reconfiguration across cart and checkout processes, preserving the referral-specific customizations throughout the entire purchase workflow.

The session persistence may additionally maintain reconfiguration across return visits within a time window, where customers returning to the e-commerce site within a specified period may continue to experience the same referral-specific customizations. In some cases, the session persistence may maintain reconfiguration across cross-device sessions, enabling customers to experience consistent referral-specific customizations when accessing the e-commerce site from different devices or browsers while maintaining their session context.

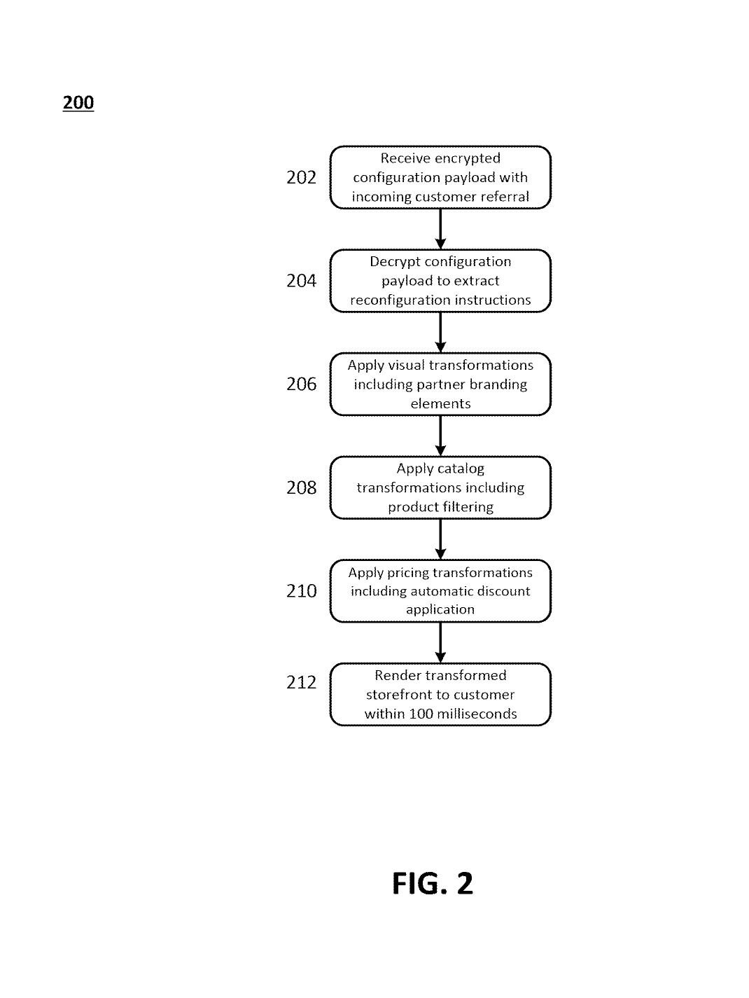

Referring to FIG. 2, a computer-implemented method 200 for transforming an e-commerce storefront in real-time based on referral context may be implemented to provide dynamic reconfiguration capabilities. The method 200 may begin with step 202, where an encrypted configuration payload may be received with an incoming customer referral. The encrypted configuration payload may contain reconfiguration instructions that specify how the e-commerce storefront should be modified based on the referral source context.

The method 200 may proceed to step 204, where the configuration payload may be decrypted to extract reconfiguration instructions. The decryption process may utilize organization-specific encryption keys to ensure secure transmission of configuration data between the referring partner and the target e-commerce store. In some cases, the decryption may reveal structured data that includes visual modification parameters, catalog filtering rules, and pricing adjustment specifications.

With continued reference to FIG. 2, the method 200 may advance to step 206, where visual transformations may be applied to the storefront interface. The visual transformations may include injecting partner branding elements, modifying color schemes and typography, replacing or augmenting hero banners, and customizing navigation elements. In some cases, the visual transformations may be implemented through CSS injection with scoped selectors that target specific elements of the storefront without affecting the overall site structure. JavaScript-based DOM manipulation may be employed to dynamically modify page elements in real-time. The visual transformations may also include responsive design adjustments that adapt the storefront appearance based on the customer's device capabilities and screen size. Animation and transition effects may be applied to create smooth visual changes that enhance the user experience during the transformation process.

The method 200 may continue to step 208, where catalog transformations may be applied to modify product presentation and selection. The catalog transformations may include filtering products to show only relevant categories, creating virtual collections specific to the referral source, reordering product displays based on partner preferences, and highlighting partner-recommended items. In some cases, machine learning-based product recommendations may be generated using algorithms that analyze customer behavior patterns and referral source characteristics. Collaborative filtering using partner audience data may be implemented to suggest products that align with the preferences of customers from similar referral sources. Real-time inventory checking for availability may be performed to ensure that displayed products are currently in stock and available for purchase. Geographic filtering based on customer location may be applied to show products that can be delivered to the customer's region or are available at nearby physical store locations.

As further shown in FIG. 2, the method 200 may proceed to step 210, where pricing transformations may be applied to adjust promotional offers and discount structures. The pricing transformations may include automatic discount application, partner-specific promotional codes, modified shipping thresholds, and exclusive bundle offerings. In some cases, dynamic pricing based on customer lifetime value may be implemented to provide personalized pricing tiers for different customer segments. Time-limited offers with countdown timers may be displayed to create urgency and encourage immediate purchase decisions. Quantity-based bulk discounts may be applied to incentivize larger order volumes. Cross-sell and upsell recommendations may be generated to suggest complementary products or premium alternatives that align with the customer's current selection and referral context.

The method 200 may conclude with step 212, where the transformed storefront may be rendered to the customer within 100 milliseconds of request reception. The rapid rendering time may be achieved through optimized processing algorithms and efficient data handling techniques that minimize latency during the transformation process. In some cases, the rendering process may utilize cached configuration elements and pre-compiled transformation templates to accelerate the delivery of the reconfigured storefront experience.

The method 200 may further include secure customer data handling through AES-128-CBC encryption implementation. Customer data may be encrypted at the source using AES-128-CBC encryption with organization-specific keys that provide unique security credentials for each participating organization. The encrypted data may be transmitted within the configuration payload along with an initialization vector that ensures secure data transfer between systems. Transfer timestamp validation may be performed to ensure data freshness within a 2-hour window, preventing the use of outdated or potentially compromised configuration data. The data may be decrypted at the target store using the organization's decryption key, which corresponds to the encryption key used at the source. The customer data may be used to enable pre-filled checkout forms, personalized greetings and messaging, location-based inventory display, and order history tracking that enhance the personalized shopping experience. Audit logs of all data access operations may be maintained to provide security monitoring and compliance tracking capabilities.

The method 200 may also incorporate analytics and optimization capabilities that measure and improve reconfiguration effectiveness. Tracking metrics for each configuration may include conversion rates, average order values, time to purchase, and cart abandonment rates that provide quantitative measures of configuration performance. An A/B testing framework may be implemented to compare different reconfiguration variants, reconfigured versus non-reconfigured experiences, and timing of reconfiguration application to identify optimal configuration strategies. Machine learning optimization may be employed to predict optimal configurations, personalize experiences based on customer segments, and automatically adjust underperforming configurations based on real-time performance data. Attribution tracking may link sales to specific reconfigurations, enabling accurate measurement of the revenue impact generated by different configuration approaches and partner relationships.

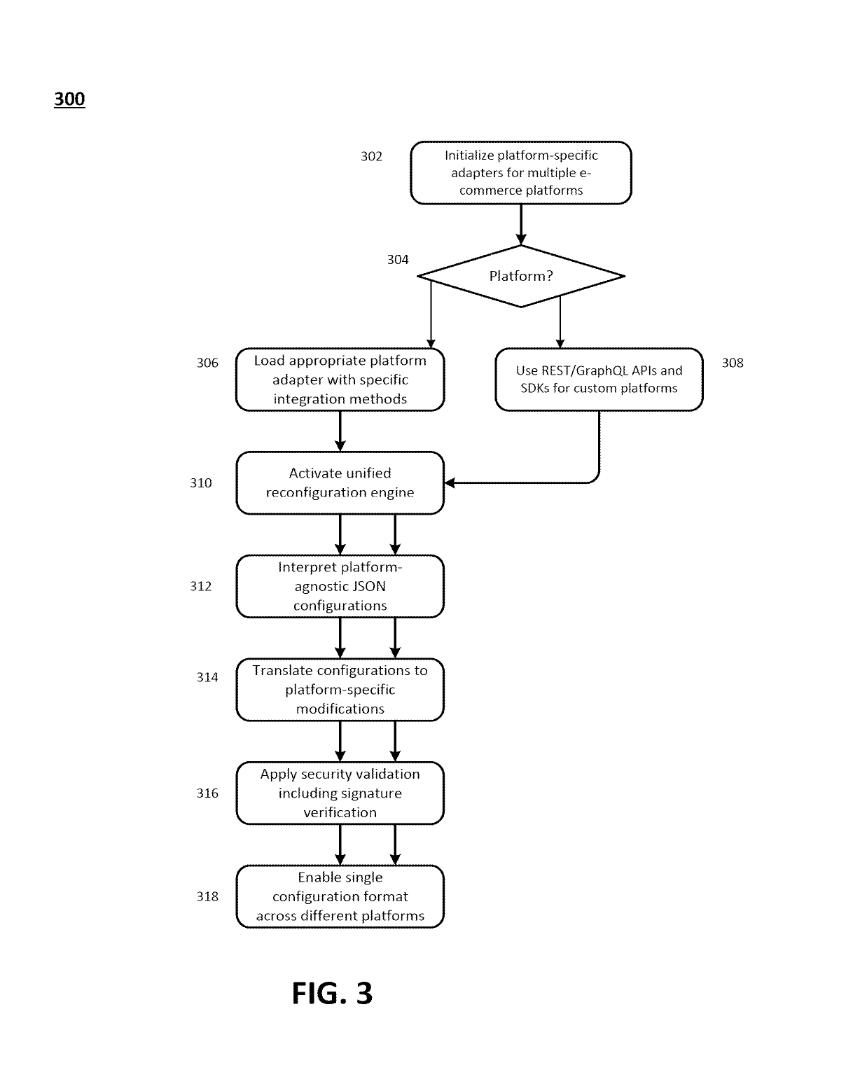

Referring to FIG. 3, a method 300 for enabling dynamic reconfiguration across multiple e-commerce platforms may be implemented through a plugin system architecture. The method 300 may begin at step 302, where platform-specific adapters are initialized for multiple e-commerce platforms. The platform-specific adapters may be configured to interface with different e-commerce platforms, each having distinct technical requirements and integration approaches.

The method 300 may proceed to step 304, which involves a decision point to determine the specific e-commerce platform type. At step 304, the system may evaluate whether the target platform is Shopify, BigCommerce, Magento, Salesforce Commerce Cloud, WooCommerce, or a custom platform. This determination may be based on platform identification parameters or configuration settings provided during the initialization process.

When the platform is identified as one of the recognized platforms, the method 300 may advance to step 306, where the appropriate platform adapter is loaded with specific integration methods. For Shopify platforms, the adapter may utilize Liquid template modification and Script Tags to implement reconfiguration functionality. The Shopify adapter may modify server-side rendering before page generation by manipulating Liquid templates and may inject client-side scripts for progressive enhancement through Script Tags.

In some cases, for BigCommerce platforms, the adapter may employ Page Builder API and Script Manager to achieve reconfiguration capabilities. The BigCommerce adapter may integrate with platform-native features through the Page Builder API and may maintain platform-specific optimizations using the Script Manager functionality.

For Magento platforms, the adapter may use Layout XML and Observer patterns to implement dynamic reconfiguration. The Magento adapter may modify server-side rendering before page generation through Layout XML modifications and may integrate with platform-native features using Observer patterns to respond to system events.

With continued reference to FIG. 3, for Salesforce Commerce Cloud platforms, the adapter may utilize ISML templates and cartridges to enable reconfiguration functionality. The Salesforce Commerce adapter may modify server-side rendering before page generation by manipulating ISML templates and may maintain platform-specific optimizations through cartridge architecture.

For WooCommerce platforms, the adapter may employ WordPress hooks and filters to implement reconfiguration capabilities. The WooCommerce adapter may inject client-side scripts for progressive enhancement using WordPress hooks and may integrate with platform-native features through the WordPress filter system.

When the platform is not one of the recognized platforms, the method 300 may proceed to step 308, where REST/GraphQL APIs and SDKs are used for custom platforms. At step 308, the system may utilize standardized API interfaces to communicate with custom e-commerce platforms that do not have dedicated adapters. The custom platform adapter may provide flexibility for integrating with proprietary or less common e-commerce systems.

Both step 306 and step 308 may converge at step 310, where a unified reconfiguration engine is activated. The unified reconfiguration engine may serve as a central processing component that coordinates reconfiguration activities across different platform types while maintaining consistency in functionality.

As further shown in FIG. 3, the method 300 may continue to step 312, where platform-agnostic JSON configurations are interpreted. At step 312, the unified reconfiguration engine may process JSON-based configuration documents that contain reconfiguration instructions in a standardized format, regardless of the target platform type.

The method 300 may then advance to step 314, where the configurations are translated to platform-specific modifications. At step 314, the unified reconfiguration engine may convert the platform-agnostic JSON configurations into platform-specific implementation details that correspond to the particular requirements and capabilities of each e-commerce platform.

The method 300 may proceed to step 316, where security validation is applied, including signature verification. At step 316, the system may implement security validation measures that include configuration signature verification to ensure authenticity, timestamp validation to prevent replay attacks, schema validation to prevent injection attacks, and sandboxed execution of custom scripts to maintain system security.

The method 300 may conclude at step 318, where a single configuration format is enabled across different e-commerce platforms. At step 318, the system may provide the capability for a unified configuration approach that can reconfigure stores on different e-commerce platforms using the same configuration document format, thereby simplifying the management of multi-platform reconfiguration scenarios.

The platform-specific adapters may provide additional capabilities beyond basic reconfiguration functionality. In some cases, the adapters may modify server-side rendering before page generation by intercepting and altering the rendering process at the server level before content is delivered to customers. The adapters may also inject client-side scripts for progressive enhancement, allowing for dynamic modifications to occur after the initial page load.

The platform-specific adapters may integrate with platform-native features to leverage existing functionality and maintain compatibility with platform-specific tools and extensions. The adapters may also maintain platform-specific optimizations to ensure that reconfiguration operations do not negatively impact performance characteristics that are particular to each platform type.

The unified reconfiguration engine may include additional components to support robust operation across multiple platforms. In some cases, the engine may include a configuration cache for performance optimization, reducing the processing overhead associated with repeated configuration operations. The engine may also implement fallback mechanisms for unsupported features, ensuring graceful operation when certain reconfiguration capabilities are not available on specific platforms.

The unified reconfiguration engine may perform version compatibility checking to ensure that configuration operations are compatible with the specific version of each e-commerce platform. The engine may also provide graceful degradation for older platforms, maintaining basic functionality even when advanced features are not supported by legacy platform versions.

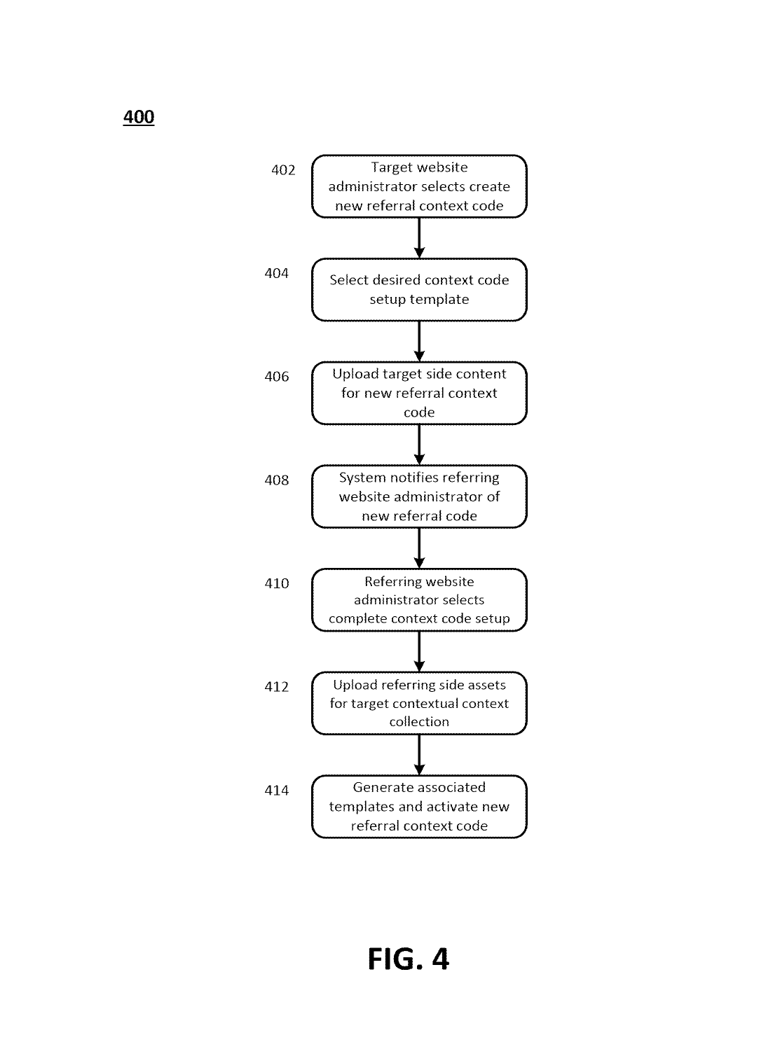

Referring to FIG. 4, a method 400 illustrates the system setup process for dynamically reconfiguring an e-commerce storefront based on referral source. The method 400 may enable both target website administrators and referring website administrators to collaborate in establishing the configuration elements needed for dynamic storefront reconfiguration through a bidirectional workflow.

The method 400 may begin with a step 402, where the target website administrator selects create new referral context code. In some cases, this initial step 402 may initiate the configuration process by allowing the target website administrator to establish a new referral relationship. The step 402 may provide the foundation for creating customized experiences for customers arriving from specific referral sources.

Following the initial selection, the method 400 may proceed to a step 404, where the administrator selects the desired context code setup template. The step 404 may enable the target website administrator to choose from predefined templates that specify the types of configuration elements available for the new referral context code. In some cases, the step 404 may provide structure and guidance for the subsequent configuration process.

The method 400 may continue to a step 406, where the target side content for the new referral context code is uploaded. During the step 406, the target website administrator may contribute configuration elements such as visual modifications, catalog filtering rules, pricing adjustments, and content messaging that will be associated with the new referral context code. The step 406 may establish the target store's contribution to the bidirectional configuration agreement.

As shown in FIG. 4, the method 400 may advance to a step 408, where the system notifies the referring website administrator of the new referral code. The step 408 may facilitate communication between the parties by alerting the referring website administrator that a new referral context code has been created and requires completion. In some cases, the step 408 may include providing access credentials or instructions for the referring website administrator to complete their portion of the setup process.

The method 400 may proceed to a step 410, where the referring website administrator selects complete context code setup. The step 410 may enable the referring website administrator to access the partially configured referral context code and begin contributing their configuration elements. In some cases, the step 410 may provide the referring website administrator with visibility into the target store's contributions and the overall configuration structure.

With continued reference to FIG. 4, the method 400 may continue to a step 412, where the referring side assets for the target contextual context collection are uploaded. During the step 412, the referring website administrator may contribute elements such as branding components, customer context information, and campaign parameters that will influence how the target storefront appears to referred customers. The step 412 may complete the bidirectional contribution process by establishing both parties' input to the configuration.

The method 400 may conclude with a step 414, where the system generates associated templates and activates the new referral context code. The step 414 may combine the contributions from both the target website administrator and the referring website administrator to create functional templates and configuration documents. In some cases, the step 414 may generate referral request templates for the referring website and contextual configuration document templates for the target website, enabling the referral context code to become operational for processing customer referrals.

The method 400 may demonstrate the collaborative nature of the setup process, where both target website and referring website administrators contribute their respective assets and configurations before the referral context code becomes functional. The bidirectional workflow of the method 400 may ensure that both parties have input into the customer experience while maintaining the flexibility to modify configurations as needed for different referral relationships.

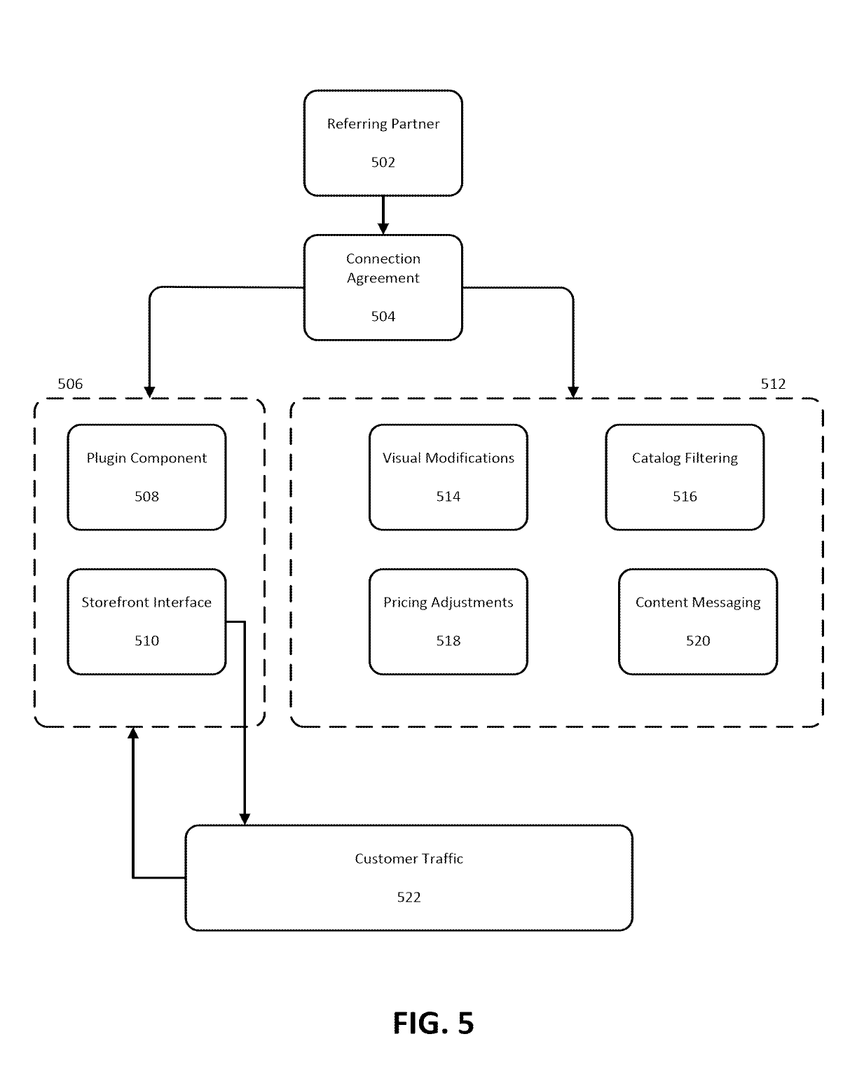

Referring to FIG. 5, an e-commerce reconfiguration system 500 may be configured to dynamically reconfigure an e-commerce storefront based on referral source. The e-commerce reconfiguration system 500 may include a referring partner 502, a connection agreement 504, an e-commerce store 506, and a JSON configuration document 512. The e-commerce store 506 may contain a plugin component 508 and a storefront interface 510. Customer traffic 522 may flow into and out of the e-commerce reconfiguration system 500.

The referring partner 502 may connect to the connection agreement 504, which may establish the relationship between the referring partner 502 and the e-commerce store 506. The connection agreement 504 may enable bidirectional configuration contribution between the referring partner 502 and the e-commerce store 506. In some cases, the connection agreement 504 may include source partner contribution specifications that define what configuration elements the referring partner 502 may provide. The connection agreement 504 may also include target store contribution specifications that outline what configuration elements the e-commerce store 506 may contribute. The connection agreement 504 may further include mutual approval requirements that ensure both parties agree to configuration changes. In some cases, the connection agreement 504 may include modification workflows requiring bilateral consent before any changes to the configuration may be implemented.

As shown in FIG. 5, the connection agreement 504 may also connect to the JSON configuration document 512, enabling the configuration specifications to be defined. The JSON configuration document 512 may specify reconfiguration instructions including visual modifications to the storefront appearance, catalog filtering and product presentation rules, pricing and promotional adjustments, and content injection and messaging. The JSON configuration document 512 may include visual modifications 514, catalog filtering 516, pricing adjustments 518, and content messaging 520.

The JSON configuration document 512 may support template variables for dynamic content insertion that allow personalized content to be inserted based on customer data or referral context. In some cases, the JSON configuration document 512 may support conditional logic for customer segmentation that enables different configurations to be applied based on customer characteristics or behavior. The JSON configuration document 512 may also support A/B testing variants for optimization that allow different configuration versions to be tested simultaneously. In some cases, the JSON configuration document 512 may support progressive enhancement based on device capabilities that adapt the configuration based on the customer's device specifications.

With continued reference to FIG. 5, within the e-commerce store 506, the plugin component 508 may interface with both the JSON configuration document 512 and the storefront interface 510. The plugin component 508 may intercept incoming referred traffic, extract and validate the configuration document, apply reconfigurations before page rendering, and maintain the reconfigured state during the shopping session. The plugin component 508 may receive customer traffic 522 and process the incoming referrals, while the storefront interface 510 may present the reconfigured experience back to the customer traffic 522.

The plugin component 508 may include security validation comprising configuration signature verification, timestamp validation to prevent replay attacks, schema validation to prevent injection attacks, and sandboxed execution of custom scripts. In some cases, the configuration signature verification may ensure that configuration documents have not been tampered with during transmission. The timestamp validation may prevent replay attacks by ensuring that configuration documents are within an acceptable time window. The schema validation may prevent injection attacks by validating that configuration documents conform to expected data structures. The sandboxed execution of custom scripts may provide a secure environment for executing configuration-related code.

The e-commerce reconfiguration system 500 may preserve customer context during the referral process wherein the customer's journey from the referring site may be maintained. In some cases, personalization data may be securely transmitted between the referring partner 502 and the e-commerce store 506. Shopping cart contents may be pre-populated based on the referral context, and customer preferences may influence the reconfiguration applied by the plugin component 508.

As further shown in FIG. 5, the visual modifications 514 may include changes to the storefront appearance such as color schemes, typography, branding elements, and layout modifications. The catalog filtering 516 may include product presentation rules that determine which products are displayed and how they are organized. The pricing adjustments 518 may include promotional modifications such as discounts, special offers, and pricing tiers specific to the referring partner 502. The content messaging 520 may include injected content such as welcome messages, promotional text, and partner-specific information.

The e-commerce reconfiguration system 500 may enable multiple parties to contribute to storefront reconfiguration. In some cases, a primary partner may provide base configuration that establishes the foundational reconfiguration elements. Secondary contributors may add layers including payment providers offering financing options, shipping partners providing delivery options, warranty providers adding protection plans, and charity partners enabling donation options. The e-commerce reconfiguration system 500 may include conflict resolution that determines precedence when configurations overlap. Revenue sharing may be based on configuration contribution, allowing multiple parties to receive compensation based on their contribution to the customer experience.

The e-commerce reconfiguration system 500 may enable integrating content creator audiences with e-commerce stores through reconfiguration. In some cases, a content creator may define their brand elements and audience preferences that specify how the storefront should be configured for their audience. The e-commerce store 506 may specify compatible products and offers that align with the content creator's brand and audience. The e-commerce reconfiguration system 500 may generate a configuration that reflects the creator's aesthetic, highlights creator-endorsed products, provides exclusive creator audience pricing, and maintains creator narrative throughout purchase. Revenue sharing may be based on configuration-attributed sales, allowing content creators to receive compensation for sales generated through their specific configuration.

The e-commerce reconfiguration system 500 may enable adapting national e-commerce stores to local markets through reconfiguration. The e-commerce reconfiguration system 500 may identify customer geographic location from referral source, allowing location-specific configurations to be applied. The storefront may be reconfigured to show local store inventory and availability, regional pricing and promotions, local delivery and pickup options, and community-specific content and causes. In some cases, the e-commerce reconfiguration system 500 may maintain national brand consistency while enabling local customization, ensuring that local adaptations do not compromise the overall brand identity.

The e-commerce storefront may present a different experience to each customer based on their referral source while using the same underlying platform and inventory. The plugin component 508 may apply different configurations from the JSON configuration document 512 based on the referring partner 502 that directed the customer traffic 522 to the e-commerce store 506. The storefront interface 510 may render the customized experience while maintaining access to the same product catalog and store functionality.

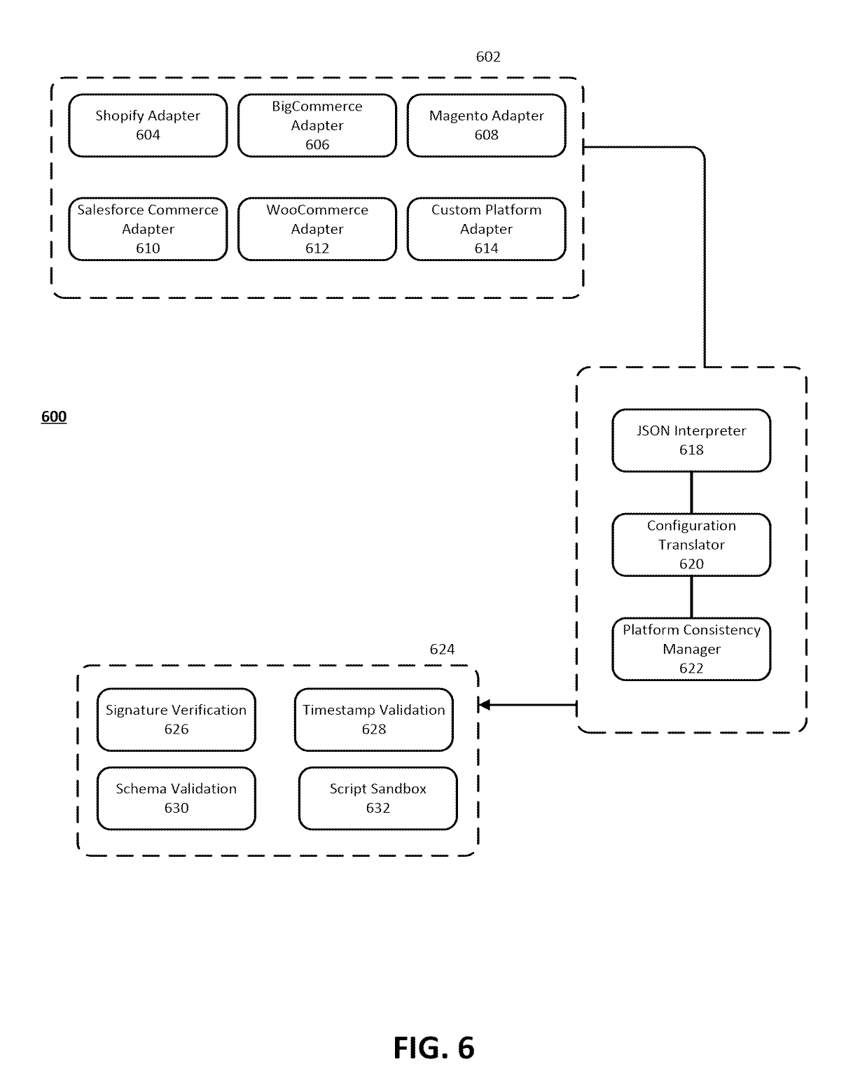

Referring to FIG. 6, a multi-platform plugin system 600 may enable dynamic reconfiguration across multiple e-commerce platforms through a modular architecture that accommodates diverse platform requirements while maintaining consistency. The multi-platform plugin system 600 may comprise platform adapters 602, a unified reconfiguration engine 616, and security validation 624 components that work together to provide seamless reconfiguration capabilities across different e-commerce environments.

The platform adapters 602 may include multiple platform-specific adapters designed to interface with different e-commerce platforms and their unique technical requirements. A Shopify adapter 604 may utilize Liquid template modification and Script Tags to implement reconfigurations within the Shopify ecosystem. A BigCommerce adapter 606 may employ Page Builder API and Script Manager functionality to modify BigCommerce storefronts. A Magento adapter 608 may use Layout XML and Observer patterns to integrate with Magento's architecture. A Salesforce Commerce adapter 610 may utilize ISML templates and cartridges to work within the Salesforce Commerce Cloud environment. A WooCommerce adapter 612 may leverage WordPress hooks and filters to modify WooCommerce installations. A custom platform adapter 614 may use REST/GraphQL APIs and SDKs to interface with proprietary or less common e-commerce platforms.

As shown in FIG. 6, the platform-specific adapters may modify server-side rendering before page generation by intercepting template processing and injecting configuration-specific modifications at the server level. The platform adapters 602 may inject client-side scripts for progressive enhancement, allowing for dynamic modifications that occur after initial page load. The adapters may integrate with platform-native features by utilizing each platform's built-in functionality and APIs to ensure compatibility and performance. The platform adapters 602 may maintain platform-specific optimizations by implementing caching strategies, database query optimizations, and rendering techniques that are tailored to each platform's architecture.

The unified reconfiguration engine 616 may serve as the central processing component that coordinates between the platform adapters 602 and provides consistent functionality across different platforms. A JSON interpreter 618 may parse and validate incoming configuration documents to extract reconfiguration instructions. A configuration translator 620 may convert platform-agnostic JSON configurations into platform-specific modifications that can be implemented by the respective adapters. A platform consistency manager 622 may ensure that reconfigurations maintain consistent behavior and appearance across different e-commerce platforms despite their underlying technical differences.

With continued reference to FIG. 6, the unified reconfiguration engine 616 may include a configuration cache for performance optimization that stores frequently accessed configurations in memory to reduce processing time and database queries. The unified reconfiguration engine 616 may implement fallback mechanisms for unsupported features that provide alternative implementations when specific functionality is not available on a particular platform. Version compatibility checking may ensure that configurations are compatible with the installed version of each e-commerce platform. Graceful degradation for older platforms may allow the system to function with reduced functionality on legacy platform versions while maintaining core reconfiguration capabilities.

The security validation 624 component may implement multiple layers of security to protect against malicious configurations and ensure data integrity. Signature verification 626 may validate that configuration documents originate from authorized sources and have not been tampered with during transmission. Timestamp validation 628 may prevent replay attacks by ensuring that configuration requests are within acceptable time windows. Schema validation 630 may prevent injection attacks by validating that configuration documents conform to expected data structures and do not contain malicious code. A script sandbox 632 may provide isolated execution environments for custom scripts to prevent unauthorized access to system resources.

The multi-platform plugin system 600 may further comprise a distributed system for managing reconfigurations at scale to handle high-volume traffic and ensure reliable performance. A centralized configuration repository may store all active configurations in a secure, accessible database that serves as the authoritative source for configuration data. Edge caching may distribute configurations geographically by storing frequently accessed configurations at multiple geographic locations to reduce latency and improve response times. Real-time synchronization may ensure configuration consistency across all distributed components by propagating updates immediately to all cache locations and processing nodes. Load balancing may distribute reconfiguration processing across multiple servers to handle concurrent requests efficiently and prevent system overload. Failover mechanisms may ensure availability during outages by automatically redirecting traffic to backup systems when primary components become unavailable.

As further shown in FIG. 6, the multi-platform plugin system 600 may include a marketplace of configuration templates that enables discovery and implementation of pre-built reconfigurations. The marketplace may organize templates into categories including industry-specific configurations tailored for particular business sectors, seasonal and holiday themes that adapt storefronts for temporal events, partnership types that define different collaboration models, and conversion-optimized layouts that have been tested for effectiveness. Customization tools may allow users to adapt templates to their specific requirements by modifying visual elements, product selections, and promotional offers. Performance data from other implementations may provide insights into the effectiveness of different configuration templates based on real-world usage statistics. Automated compatibility checking may verify that selected templates are compatible with specific store platforms and versions before implementation.

The distributed architecture of the multi-platform plugin system 600 may enable horizontal scaling to accommodate growing numbers of e-commerce stores and increasing traffic volumes. The system may automatically provision additional processing resources during peak usage periods and scale down during lower demand to optimize resource utilization. Geographic distribution of system components may reduce latency for users in different regions while maintaining consistent functionality and security standards across all locations.

1. A system for dynamically reconfiguring an e-commerce storefront based on referral source, comprising:
a connection agreement established between a referring partner and an e-commerce store, wherein both the referring partner and the e-commerce store contribute configuration elements;
a contextual configuration object that provides reconfiguration instructions for at least one of visual modifications to the storefront appearance, catalog filtering and product presentation rules, pricing and promotional adjustments, or content injection and messaging;
a plugin component configured to intercept incoming referred traffic, extract and validate the configuration object, apply reconfiguration before page rendering, and maintain the reconfigured state during a shopping session.

2. The system of claim 1, wherein the connection agreement includes one or more of source partner contribution specifications, target store contribution specifications, mutual approval requirements, or modification workflows.

3. The system of claim 1, wherein the contextual configuration object supports template variables for one or more of dynamic content insertion, conditional logic for customer segmentation, testing variants for optimization, and progressive enhancement based on device capabilities.

4. The system of claim 1, further comprising customer context preservation wherein a customer's browsing from the referring site is maintained, personalization data is securely transmitted, shopping cart contents can be pre-populated, and customer preferences influence the reconfiguration.

5. The system of claim 1, wherein the plugin component is configured to perform security validation comprising one or more of configuration signature verification, timestamp validation to prevent replay attacks, schema validation to prevent injection attacks, or execution of custom scripts.

6. The system of claim 1, further comprising a component configured to perform adaptive storefront reconfiguration that changes during the customer’s browsing the adaptive reconfiguration comprising:
initial reconfiguration based on referral source,
progressive reconfiguration based on the customer’s actions, the customer’s time on site triggering engagement features, cart contents, and exit intent activating retention offers, and
session persistence maintaining reconfiguration across multiple page views, cart and checkout processes, return visits within a time window, and cross-device sessions.

7. The system of claim 1, further comprising:
a component configured to enable multiple parties to contribute to storefront reconfiguration, comprising a primary partner providing base configuration, secondary contributors adding layers including payment providers offering financing options, shipping partners providing delivery options, warranty providers adding protection plans, and charity partners enabling donation options, conflict resolution determining precedence when configurations overlap, and revenue sharing based on configuration contribution.

8. A non-volatile computer readable medium storing computer-executable instructions that, when executed, perform a method for transforming an e-commerce storefront in real-time based on referral context, the instructions comprising:
receiving an encrypted configuration payload with an incoming customer referral;
decrypting the configuration payload to extract reconfiguration instructions;
applying visual transformations including injecting partner branding elements, modifying color schemes and typography, replacing or augmenting hero banners, and customizing navigation elements;
applying catalog transformations including filtering products to show only relevant categories, creating virtual collections specific to the referral source, reordering product displays based on partner preferences, and highlighting partner-recommended items;
applying pricing transformations including automatic discount application, partner-specific promotional codes, modified shipping thresholds, and exclusive bundle offerings; and
rendering the transformed storefront to the customer subsequent to request reception.

9. The computer-readable medium of claim 8, wherein the applied visual transformations include at least one of CSS injection with scoped selectors, JavaScript-based DOM manipulation, responsive design adjustments, or animation and transition effects.

10. The computer-readable medium of claim 8, wherein the applied catalog transformations include at least one of machine learning-based product recommendations, collaborative filtering using partner audience data, real-time inventory checking for availability, or geographic filtering based on customer location.

11. The computer-readable medium of claim 8, wherein the applied pricing transformations include at least one of dynamic pricing based on customer lifetime value, time-limited offers with countdown timers, quantity-based bulk discounts, or cross-sell and upsell recommendations.

12. The computer-readable medium of claim 8, wherein the instructions further comprise:
encrypting customer data at the source using AES-128-CBC encryption with organization-specific keys, transmitting encrypted data within the configuration payload along with initialization vector, validating transfer timestamp to ensure data freshness within a 2-hour window, decrypting data at the target store using the organization's decryption key, using customer data to enable pre-filled checkout forms, personalized greetings and messaging, location-based inventory display, and order history tracking, and maintaining audit logs of all data access operations.

13. The computer-readable medium of claim 8, wherein the instructions further comprise:
tracking metrics for each configuration including conversion rates, average order values, time to purchase, and cart abandonment rates,
comparing different reconfiguration variants, experiences based on reconfigured and non-reconfigured applications, and timing of reconfiguration application,
predicting optimal configurations,
personalizing based on customer segments, and
automatically adjusting underperforming configurations, and attribution tracking linking sales to specific reconfigurations.

14. A non-volatile computer-readable medium storing executable components that, when executed, operate as a plugin system for enabling dynamic reconfiguration across multiple e-commerce platforms, the plugin system comprising:
adapters for template modification;
a reconfiguration engine configured to interpret context-based configuration objects, translate the configuration objects, and maintain consistency across different platforms; and
a security validator configured to perform configuration signature verification, timestamp validation to prevent replay attacks, schema validation to prevent injection attacks, and sandboxed execution of custom scripts;
wherein a single configuration format can reconfigure stores on different e-commerce platforms.

15. The computer-readable medium of claim 14, wherein platform-specific adapters modify server-side rendering before page generation, inject client-side scripts for progressive enhancement, integrate with platform-native features, and maintain platform-specific optimizations.

16. The computer-readable medium of claim 14, wherein the unified reconfiguration engine includes at least one of a configuration cache to perform optimization, , version compatibility checking, and degradation for older platforms.

17. The computer-readable medium of claim 14, further comprising:
a component configured to manage reconfigurations,
a centralized configuration repository storing all active configurations, edge caching distributing configurations geographically, real-time synchronization ensuring configuration consistency, load balancing distributing reconfiguration processing, and failover mechanisms.

18. The computer-readable medium of claim 14, further comprising:
a marketplace of configuration templates, categories including industry-specific configurations, partnership types, and conversion-optimized layouts, customization tools for adapting templates, performance data from other implementations, and automated compatibility checking with store platforms.

19. The computer-readable medium of claim 14, wherein the system is configured to integrate content creator audiences with e-commerce stores through reconfiguration.

20. The computer-readable medium of claim 14, wherein the system is configured to adapt national e-commerce stores to local markets through reconfiguration.
